(19) United States
(12) Patent Application Publication
(10) Pub. No.: US 2015/0202785 A1
(43) Pub. Date: Jul. 23, 2015

(54) Powered Drywall Trim Cutter

(71) Applicants: Douglass Wambaugh, Bend, OR (US); Timothy Smythe, Bend, OR (US)

(72) Inventors: Douglass Wambaugh, Bend, OR (US); Timothy Smythe, Bend, OR (US)

(21) Appl. No.: 14/551,658

(22) Filed: Nov. 24, 2014

Related U.S. Application Data
(63) Continuation-in-part of application No. 13/476,481, filed on May 21, 2012, now abandoned.
Application No. 13/476,481 is a continuation-in-part of application No. 12/380,672, filed on Mar. 2, 2009, now abandoned.
Application No. 12/380,672 is a continuation-in-part of application No. 11/258,820, filed on Oct. 26, 2005, now abandoned.

(51) Int. Cl. B26D 5/10; B26D 1/38; B26B 27/00; E04F 21/00

(52) U.S. Cl. CPC B26D 5/10; E04F 21/00; B26D 1/385; B26B 27/00

(57) ABSTRACT

A powered cutter for cutting drywall tape or plastic drywall trim. The cutter can contain a blade, a means to move the blade through the material or move the material over the blade, a source of power to create the movement, a means for the user to release the power initiating the movement to create the cut. The cutter can be powered by springs, a motor, hydraulics, or by any other means. The preferred embodiment is a spring-powered cutter where the spring is cocked with a lever and released with a trigger. The spring causes a mass to rotate that carries enough angular momentum to cause the blade to cut through the drywall trim material. If the spring is of sufficient power a mass may not be needed.

This is a continuation-in-part of application Ser. No. 13/476,481 filed May 21, 2012 which was a continuation-in-part of application Ser. No. 12/380,672 filed March 2, 2009 which was is a continuation-in-part of application Ser. No. 11/258,820 filed Oct. 26, 2005. application Ser. Nos. 13/476,481, 12/380,672 and 11/258,820 are hereby incorporated by reference.

### BACKGROUND

1. Field of the Invention

The present invention relates generally to the field of drywall installation and more particularly to a cutter for plastic drywall trim product.

2. Description of the Prior Art

There are many pieces of equipment used in the drywall taping industry to help the installer apply drywall tape of various types (paper, mesh, plastic, laminates, etc) to the joints or corners between two pieces of drywall board. Many of these devices incorporate a cutter to cut the tape at the end of each joint or corner. All of these cutters on these various pieces of equipment are powered by hand, arm or finger motion at the time of each cut. That is the force of the hand, arm or finger actually powers the cutting mechanism. This can be strenuous and awkward given the repetitive nature of the work and that the installer may be in an awkward position, reaching, stretching, bending or otherwise in a bad position to perform the require motion to actuate the cutter. In addition, newer products like paper-plastic-paper laminates called plastic drywall trim are being used more and more. These products are generally too stiff and hard to cut by hand without sawing them or cutting them with heavy duty shears (like sheet metal shears).

What is needed is to power the cutter for any of these devices so all the installer has to do is pull a trigger, push a button, or otherwise release some other source of power, just like the trigger on a gun, to perform a cut, in particular to cut drywall trim pieces made of plastic, metal or other difficult to cut materials.

### SUMMARY OF THE INVENTION

The present invention relates to a powered cutter for cutting drywall tape or plastic drywall trim. The cutter can contain a blade, a means to move the blade through the material or move the material over the blade, a source of power to create the movement, a means for the user to release the power initiating the movement to create the cut. The cutter can be powered by springs, a motor, hydraulics, or by any other means. The preferred embodiment is a spring-powered cutter where the spring is cocked with a lever and released with a trigger. The spring causes a mass to rotate that carries enough angular momentum to cause the blade to cut through the drywall trim material. If the spring is of sufficient power a mass may not be needed.

### DESCRIPTION OF THE FIGURES

FIG. 1 shows an embodiment of a cutter in the relaxed or ready position.

FIG. 2 shows the cutter being cocked.

FIG. 3 shows the cutter cocked and ready to cut

FIG. 4 shows the mass and rotor, in motion, hitting the bottom of the moving blade 3.

FIG. 5 is an isometric view of the cutter completing a cut.

FIG. 6 is a second isometric view of the cutter completing a cut.

FIG. 7 shows a concept drywall trim dispenser to hold the drywall trim material and hold the cutter in position so the drywall trim material can be fed through the cutter.

FIG. 8 shows an isometric view of the cutter assembly as it might be installed and mounted

Several drawings and illustrations have been presented to better aid in the understanding of the present invention. The scope of the present invention is not limited to the figures.

### DESCRIPTION OF THE INVENTION

The present invention relates to a powered cutter for cutting drywall plastic (or other materials) trim pieces as well as drywall tape. This cutter can contain a trigger which can be any form such as a thumb operated lever, button, sliding tube, rotating handle, or squeeze handle or any other form of mechanism to activate, or release, power to drive the cut. Squeezing the trigger would be designed to require very little force or length of motion and instantaneously triggers the cutter to use its stored power to perform a cut automatically. The cutting action is normally started or initiated by human action but is powered (or carried out) by something other than human strength, for instance the stored energy of a spring. The cutting action can be powered by any kind of spring (torsion, compression, tension, etc), by electric power (linear actuator, motor, etc), by hydraulic or pneumatic power (cylinders, bellows, etc.) or any other types of power sources. This power can be used to drive a blade through any drywall trim or finishing material. For instance, a rotating mass, when driven by a spring, acquires enough angular momentum to force a blade through a piece of drywall trim or finishing material, such as drywall tape, cutting it. The material thickness may vary as different materials may be more or less difficult to cut. The stored power required to drive a cut depends on the material being cut (plastic, thick paper, metal) and it's thickness and width. Thickness can vary from thin metal (16 gage or instance) to plastics, to thick layers of paper. Widths typically range from 1-6 inches for plastic drywall trim material.

While, the powered cutter of the present invention can be used on any type of drywall tapping equipment, (bazooka's, tape dispensers, etc) and with any kind of tape material (paper, metal, mesh, plastic, laminates, etc), it is preferred to use it with plastic drywall trim material.

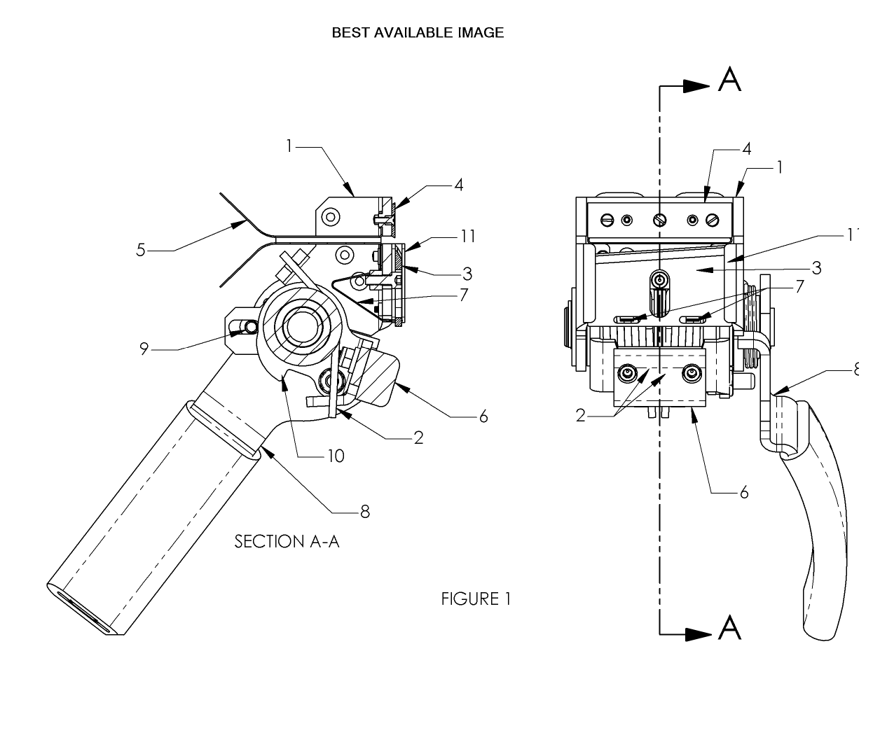

FIGS. 1, 2, 3 and 4 show a front (right) and section (left) view of the powered cutter of the present embodiment of the invention. The powered cutter shown in the particular embodiment in the figures utilizes torsion springs for power to perform the cut. The mechanism includes a frame 1, torsion springs 2, moving blade 3, Blade guide 11, stationary blade 4, drywall trim material guide 5, a mass and rotor 6, a return spring 7, a cocking handle 8 and a latch mechanism 9. These views also show the mass and rotor step 10.

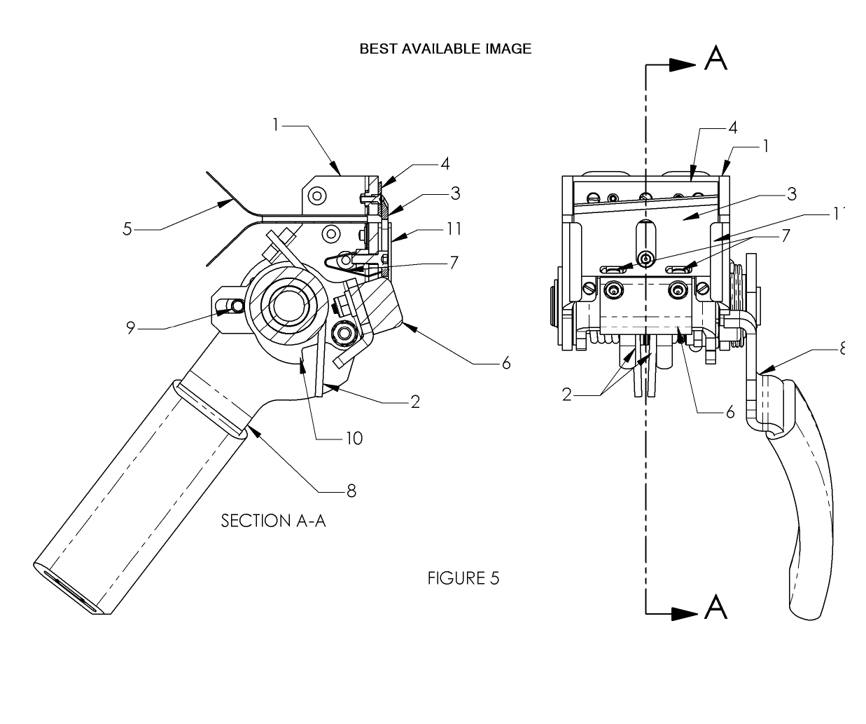

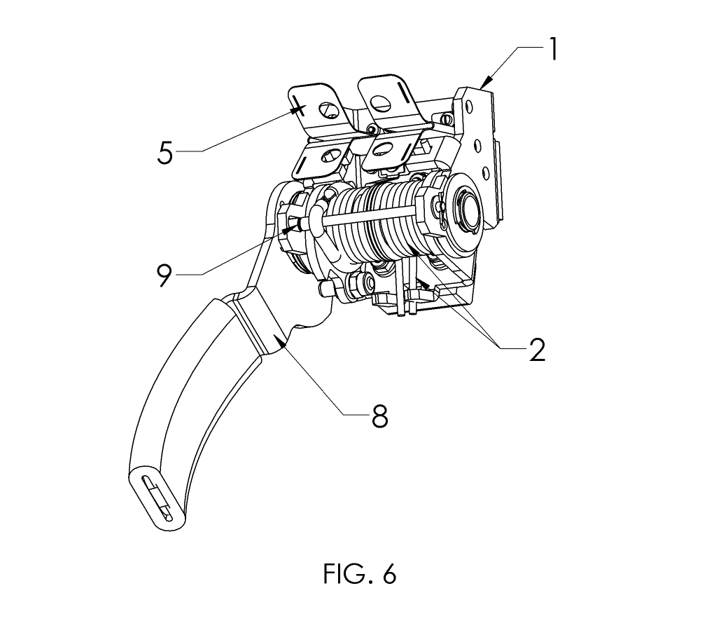

FIGS. 5 and 6 show isometric views of the cutter of the powered cutter of the present embodiment of the invention to better see the described mechanisms.

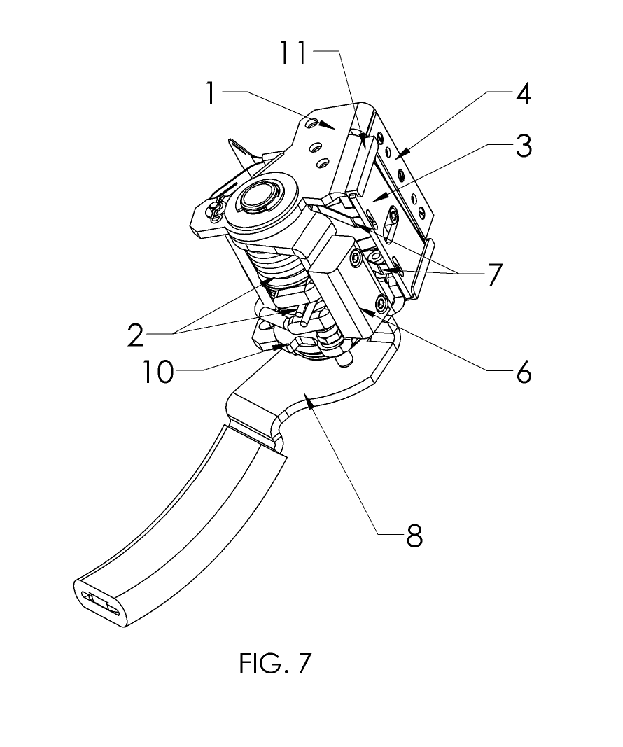

FIG. 7 shows a concept drywall trim dispenser to hold the drywall trim material and hold the cutter in position so the drywall trim material can be fed through the cutter. The drywall trim dispenser is not part of this patent but shows how the cutter might be mounted in such a device. It also shows how a trigger may be incorporated into such a device to release the latch mechanism releasing the stored power of the spring in the cutter to initiate the cut.

FIG. 1 shows an embodiment of a cutter in the relaxed or ready position. In this figure the torsion springs 2 are not compressed, the mass and rotor 6 is loose and free to rotate clockwise or counterclockwise (as viewed in the section view), the handle cocking handle 8 is free to be rotated clockwise in the section view which will begin the cocking action, the moving blade 3 is held down (cutter open) in the blade guide 11 by the return spring 7.

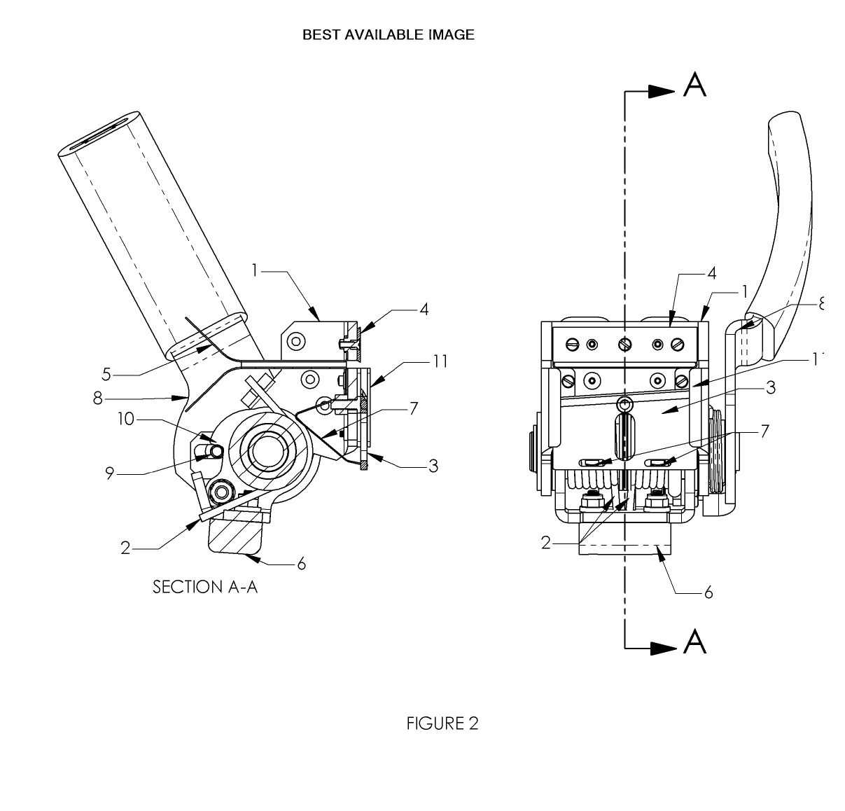

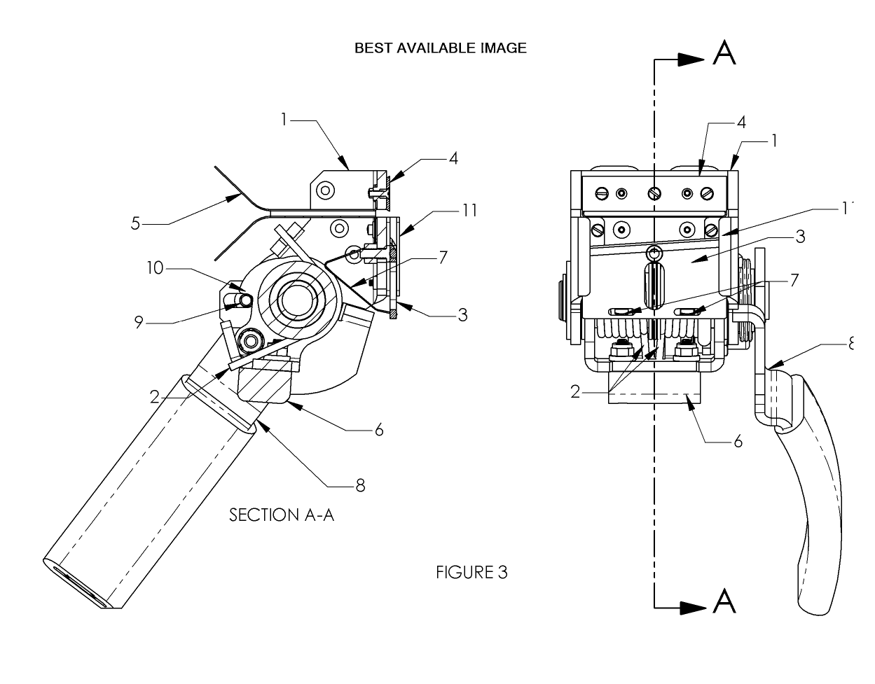

FIG. 2 shows the cutter being cocked. When the handle 8 is pulled back (rotated clockwise in the section view) it engages the mass and rotor 6 which, in turn, engages the torsion spring 2 tightening the torsion spring 2 the more the handle is rotated clockwise. The frame 1 is mounted rigidly in any drywall trim dispenser (concept shown in FIG. 7) and does not rotate. When the handle is rotated far enough (about 90 degrees from it's original position) the mass and rotor step 10 on the mass and rotor 6 engages the latch mechanism 9, holding the mass and rotor 6 in place against the force of the torsion spring 2. The handle 8 is free to go back to its relaxed position. This position is shown in FIG. 3.

FIG. 3 shows the embodiment of the cutter in the cocked, or ready to cut position and held cocked by the mass and rotor step 10 and latch mechanism 9. The leg of the torsion spring 2 is putting pressure on the mass and rotor 6 trying to rotate it counterclockwise but the mass and rotor 6 are being held in position by the mass and rotor step 10 overlapping the latch mechanism 9. The system is cocked and ready to cut.

Note that the moving blade 3 is being held down in the blade guide 3.1 by the return springs 7, and the cutter is still open. At this time a drywall trim material (a tape or plastic drywall finishing material) may be fed through the trim material guide 5 from left to right in the section views. The drywall trim material would move(or be fed) from left to right, in the section views, through the trim material guide 5 which would guide the trim material between the stationary blade 4 and the moving blade 3, which is in the down position and come out the front of the cutter assembly (to the right in the section view).

The cutter is ready to cut. Once the desired length of drywall trim material is fed through the cutter trim material guide 5 the latch mechanism 9 may be pulled back (to the left in the section views).

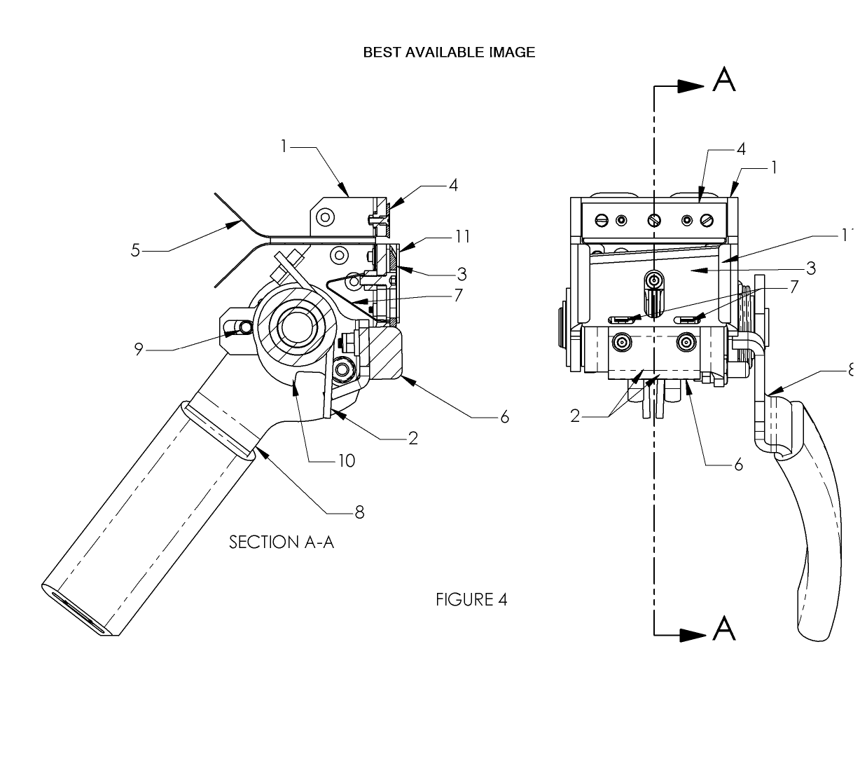

Pulling the latch mechanism 9 back (to the left in the section views) until the mass and rotor step 10 is not overlapping the latch mechanism 9 no longer holds the mass and rotor 6 and the torsion spring 2 is thus allowed to rotate the mass and rotor 6 in the counterclockwise direction. A lever (trigger) and cable system may be mounted remotely and utilized to pull the latch mechanism 9 to the left. The torsion spring 2, which has been in tension, now expends its stored energy forcing the mass and rotor 6 to rotate counterclockwise in the section views. The mass and rotor 6 rotate very quickly counterclockwise in the section views until they hit the bottom of the moving blade 3. This is the position shown in FIG. 4

FIG. 4 shows the mass and rotor 6, in motion, hitting the bottom of the moving blade 3. At this time the torsion springs 2 stops pushing on the mass and rotor 6 but the mass and rotor 6 is free to continue its rotation due to the kinetic energy of rotational momentum.

The rotational momentum of the mass and rotor 6 drives the moving blade 3 up in the blade guide 11 as the rotational momentum of the mass and rotor 6 overcomes the return springs 7 tendency to hold the moving blade 3 down, shearing the drywall trim material apart as the moving blade 3 overlaps the stationary blade 4. The end point of this motion is shown in FIG. 5.

FIG. 5 shows the moving blade 3 and following mass and rotor 6 stopped after the moving blade 3 completely overlaps the stationary blade 4 completing the cut. The moving blade 3 and the mass and rotor 6 are now free to drop rotationally (clockwise in the section view). After the cut is complete the moving blade 3 is returned to its down, or open, position by the return spring 7. The mass and rotor 6 are now loose rotationally between the bottom of the moving blade 3 and the torsion spring 6 legs. And the system is back to the position it was in the beginning (FIG. 1).

FIG. 6 shows a isometric view from below and behind the cutter assembly to better visualize the various parts.

FIG. 7 shows a isometric view from below and in front of the cutter assembly to better visualize the various parts.

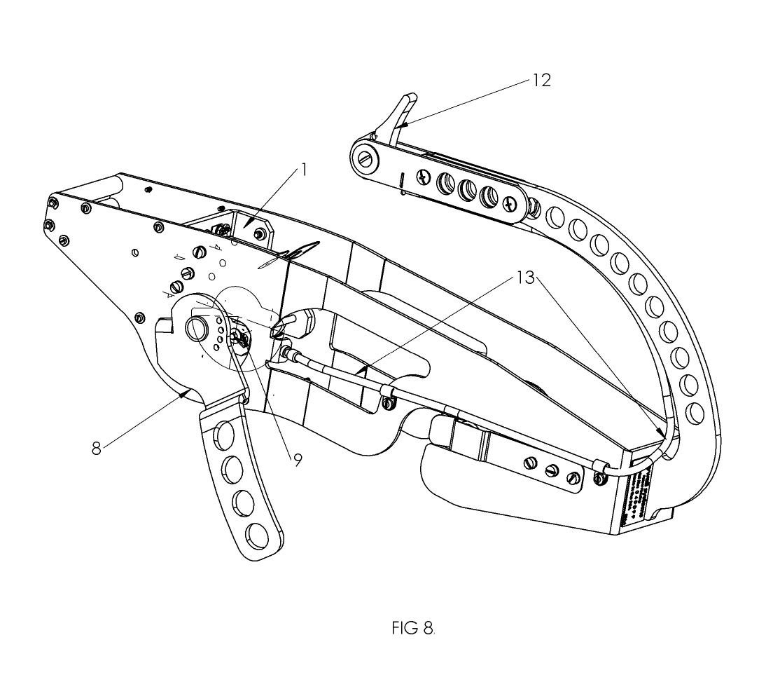

FIG. 8 shows an isometric view of the cutter assembly as it might be installed and mounted into a concept drywall trim material dispensing device or a concept tape dispensing device. This view also shows how a lever 12, or trigger, may be mounted on such a drywall trim material dispensing device and how a cable 13 could be employed to transmit lever 12 motion to the latch mechanism 9 releasing the stored energy of the torsion spring 2 initiating the cut.

The concept drywall trim, or tape dispenser, the trigger and cable are described and shown only to describe how the powered cutter might be used. They are not part of the invention being claimed. The material being dispensed could be in roll form, like most tapes, which is held in any tape dispensing device. The trim or taping material can be fed through the cutter by means of a guide 5. The guide 5 does not hinder the product moving through it, but guides the product between the moving cutting blade 3 and the stationary cutting blade 4 so that it may be cut when the mechanism is triggered by the operator. Tape or trim can be fed from a roll or straight in.

At the end of the corner or joint, the cutter is easily activated by a lever 12 or trigger mechanism which releases the stored power of the power source, a torsion spring 2 in the embodiment shown. The mass and rotor 6 are driven rotationally around the shaft by the torsion springs 2 until they impact the bottom of the moving cutting blade 3 as shown in FIG. 2 with enough momentum to cause the moving blade 3 to cut through at least ⅛ inch paper-plastic-paper drywall trim material or other drywall finishing tape material.

At the time of impact between the mass and rotor 6 and the moving cutting blade 3, the torsion springs 2 have normally stopped applying force to the mass and rotor 6, and the mass and rotor 6 are coasting with tremendous momentum as the mass and rotor 6 impacts the bottom of the moving cutting blade 3. The mass and rotor 6 impart their energy to the moving cutting blade 3 making it move past the stationary cutting blade 4 cutting the product which has been guided between the blades by the guide 5. This action happens very quickly once the mechanism has been triggered.

A return spring 7 applies a light constant force to the moving cutting blade 3 to keep it “open” (or from being over the stationary cutting blade 4) and allows product to move through the guide 5 and be applied to the joint or corner. The cutting blades are normally open and ready (cocked) during equipment operation. Once the mechanism is triggered, the cutter performs a cut without power from the operator.

While prior art cutters in drywall taping equipment require human power to perform the cut at the time of each cut, the powered cutter of the present invention only needs to be released by some light trigger mechanism, (lever, button, valve, etc.), and finds significant application in cutting plastic drywall trim pieces.

Several descriptions and illustrations have been presented to better aid in understanding the present invention. One with skill in the art will recognize that many changes and variations are possible. Each of these changes and variations is within the scope of the present invention.

We claim:

1. A drywall trim cutter used to cut plastic drywall trim comprising, in combination,
a frame containing at least a torsion spring, a rotating mass and rotor, a moving cutting blade, a stationary butting blade, and a cocking handle; wherein, said torsion spring is coupled to said moving blade, said torsion spring being tensioned by said cocking handle to a cocked position, said torsion spring releasable from said cocked position causing said rotating mass to acquire sufficient momentum to cause said moving cutting blade to close on said stationary butting blade cutting a section of plastic drywall trim up to ⅛ inch thick between said cutting blade and said stationary butting blade;
whereby said drywall trim cutter dispenses and cuts plastic drywall trim strips into cut pieces.

2. The drywall trim cutter of claim 1 further comprising a product guide that guides said drywall trim between said moving blade and said butting blade.

3. The drywall trim cutter of claim 1 further where the mass and blade are the same part.

4. A device for dispensing and cutting plastic drywall trim products comprising:
a frame adapted to be mounted on an elongated handle;
a drywall trim guide attached to said frame;
a driving spring and rotating mass contained by said frame;
a slanted, movable cutting blade that moves between a feed position and a cut position and stationary cutting blade that can be engaged by said movable cutting blade, said movable cutting blade and said stationary butting blade contained by said frame;
a cocking handle;
a retaining latch adapted to release said rotating mass from a cocked position ;
wherein, said driving spring can be cocked by said cocking handle and retained by said retaining latch, said driving spring mechanically coupled to said rotating mass; and
wherein, when said rotating mass is released, said driving spring causes said rotating mass to acquire sufficient angular momentum to cause said movable cutting blade to cut a piece of plastic drywall trim material at least ⅛ thick between said movable cutting blade and said stationary butting blade; and
wherein after cutting, a return spring causes said movable cutting blade to return from said cut position to said feed position allowing plastic drywall trim to be fed through said trim guide, said trim guide being positioned so that said plastic drywall trim feeds between said movable cutting blade and said stationary butting blade.

5. A drywall trim cutter used to cut drywall trim of any material comprising, in combination,
a frame containing at least a spring, a movable mass, a moving cutting blade, a stationary butting blade, and a cocking handle; wherein, said spring is coupled to said movable mass which is aligned to said moving blade, said spring being tensioned by said cocking handle to a cocked position, said spring releasable from said cocked position causing said mass to acquire sufficient momentum to impact said moving blade cause said moving blade to close on said stationary cutting blade cutting a section of said drywall trim material up to ⅛ inch thick between said moving cutting blade and said stationary butting blade; and
whereby said drywall trim cutter dispenses and cuts drywall trim strips into cut pieces.

6. The drywall trim cutter of claim 5 further where the mass and blade are the same part.
